(19) United States
(12) Patent Application Publication
(10) Pub. No.: US 2010/0101233 A1
(43) Pub. Date: Apr. 29, 2010

(54) Cooling Temperature Ladder and Applications Thereof

(76) Inventor: Lincoln Evans-Beauchamp, Palo Alto, CA (US)

Correspondence Address: PETERS VERNY , L.L.P., 425 SHERMAN AVENUE, SUITE 230, PALO ALTO, CA, 94306, US

(21) Appl. No.: 12/259,592

(22) Filed: Oct. 28, 2008

(51) Int. Cl. F02C 7/12; F28D 15/00

(52) U.S. Cl. 60/806; 165/104.13

(57) ABSTRACT

A reverse flow heat exchanger is combined with a thermal energy sink to generate a temperature ladder. This system is used to cool a fluid more efficiently and/or to a lower temperature than would be possible without the reverse flow heat exchanger. The cooled fluid is optionally used to cool a sensor, a superconductor, a circuit, a cooling surface, or the like. The cooled fluid is optionally combined with a catalyst to remove unwanted constituents.

### CROSS-REFERENCE TO RELATED APPLICATIONS

This application is related to U.S. patent application Ser. No. 11/800,110 filed May 3, 2007 and entitled “Particle Burner disposed between an Engine and a Turbo Charger,” which is a continuation-in-part of U.S. patent application Ser. No. 11/787,851 filed Apr. 17, 2007 and titled “Particle Burner including a Catalyst Booster for Exhaust Systems,” which is a continuation-in-part of U.S. patent application Ser. No. 11/404,424 filed Apr. 14, 2006 and titled “Particle Burning in an Exhaust System,” and also related to U.S. patent application Ser. No. 11/412,289 filed Apr. 26, 2006 and titled “Air Purification System Employing Particle Burning,” and also related to U.S. patent application Ser. No. 11/412,481 filed Apr. 26, 2006 and titled “Reverse Flow Heat Exchanger for Exhaust Systems.”

### BACKGROUND OF THE INVENTION

1. Field of the Invention

This invention relates generally to cooling systems and applications thereof.

2. Related Art

A variety of cooling systems are known in the art. These include, or example, electronic systems, chemical systems, systems based on a phase change, and systems that involve the expansion of a gas or liquid. Examples of such systems are well known to those of ordinary skill in the art. Cooling typically involves the conversion of energy from one form to another form and/or from one location to another. For example, an electronic Peltier device may be configured to move thermal energy from a first electrical junction to a second electrical junction using electrical energy. A thermal expansion may be used to cool a gas by moving energy between energy partitions.

Cooling systems are used to cool materials. For example, a cooling

system may be used to cool a superconductor, to cool an electronic circuit, to cool a surface used for freezing things, to cool a sensor (e.g., an infrared optical detector), or the like. Often the efficiency of cooling systems and the minimum temperatures that they can obtain are significant limitations. For example, the efficiency of Peltier devices are notoriously poor. Likewise, the minimum temperatures that these devices can achieve are higher than would be desired for many applications. There is, therefore, a need for cooling systems having greater efficiency and/or capable of reaching lower minimum temperatures.

The term energy partitions is used herein as in the field of thermodynamics to distinguish different rotational, vibrational and translational degrees of freedom in which energy may reside, and further to include various types of chemical bonds that may be formed or broken, potential energy, energy storage locations, or the like. The term thermal energy is used to refer to that fraction of a system's energy that is perceived as temperature. For example, energy of molecular/atomic translation is considered thermal energy.

### SUMMARY OF THE INVENTION

Various embodiments of the invention include a temperature ladder configured for cooling an object or surface. The temperature ladder comprises a reverse How heat exchanger and a thermal energy sink disposed at an intermediate point within the heat exchanger. As is described further elsewhere herein, the removal of energy at an intermediate point within the reverse flow heat exchanger can result in a feedback effect that causes the region in which energy is removed to reach a lower temperature and/or to be cooled more efficiently.

In some embodiments the thermal energy sink is configured for endothermic processes to occur. These endothermic processes may include, for example, electronic systems, chemical systems, systems based on a phase change, radiant systems, systems that involve the expansion of a gas or liquid, and/or the like. The thermal energy sink optionally includes a separate chamber disposed within the flow path of the temperature ladder. The thermal energy sink and/or reverse flow heat exchanger may take a variety of different geometrical configurations. In various embodiments the thermal energy sink is configured for heat transfer form or to external fluids or masses.

In some embodiments, the thermal energy sink and reverse flow heat exchanger are configured to cool a fluid below an ambient temperature (e.g., room temperature). In other embodiments the thermal energy sink and reverse flow heat exchanger are configured to cool a fluid to a temperature above ambient temperature but below an initial temperature.

Various embodiments of the invention include a system comprising a reverse flow heat exchanger configured to receive a fluid; and a thermal energy sink configured to cool the fluid by removing energy from at least one energy partition of the fluid, the thermal energy sink being disposed within the reverse flow heat exchanger such that the fluid cooled by the thermal energy sink pre-cools the fluid before the received fluid reaches the thermal energy sink.

Various embodiment of the invention include a method comprising: introducing a fluid into an input of a reverse flow heat exchanger: cooling the fluid using a thermal energy sink disposed within the reverse flow heat exchanger to produce cooled fluid; and passing the cooled fluid through an output of the reverse flow heat exchanger so as to pre-cool the fluid introduced into the input of the reverse flow heat exchanger before this fluid reaches the thermal energy sink.

Various embodiments of the invention include a system comprising: an impeller turbine configured to receive a gas; an engine configured to combust a mixture of a fuel and the gas resulting in an exhaust; a cooling temperature ladder comprising a reverse flow heat exchanger and a thermal energy sink disposed at an intermediate point within the reverse flow heat exchanger, the cooling temperature ladder configured to cool the exhaust; a catalyst disposed within the cooling temperature ladder at a position where the exhaust is cooled; and a drive turbine configured to receive the exhaust from the cooling temperature ladder.

### BRIEF DESCRIPTION OF THE FIGURES

FIG. 1 depicts a system comprising a reverse flow heat exchanger and a thermal energy sink, according to various embodiments of the invention.

FIG. 2 depicts a system comprising a reverse flow heat exchanger having more than one input channel, according to various embodiments of the invention.

FIG. 3 illustrates temperature as a function of position in the system of FIG. 1 at various times, according to various embodiments of the invention.

FIG. 4 depicts the system of FIG. 1 in a spiral configuration, according to various embodiments of the invention.

FIG. 5 depicts a cross sectional view along a vertical axis of the system of FIG. 4, according to various embodiments of the invention.

FIG. 6 depicts a side view of the system of FIG. 1 in a plate configuration, according to various embodiments of the invention.

FIG. 7 depicts a top view of the system of FIG. 6, according to various embodiments of the invention.

FIGS. 8 and 9 depict cross sectional views of the system of FIG. 6, according to various embodiments of the invention.

FIG. 10 depicts the system of FIG. 1 further comprising a catalyst, according to various embodiments of the invention.

FIG. 11 depicts the system of FIG. 4 further including a catalyst, according to various embodiments of the invention.

FIG. 12 depicts the system of FIG. 1 coupled to a turbine, according to various embodiments of the invention.

FIG. 13 illustrates a method of cooling, according to various embodiments of the invention.

### DETAILED DESCRIPTION

A reverse flow heat exchanger is use to improve the efficiency and/or minimum temperature of a cooling system. The cooling system may be applied to a wide variety of applications, for example, liquification of gasses, chemical processing, health care, cryo-trapping, cooling of semiconductors, quenching of hot materials, cooling of electronics, cooling of sensors, protection of temperature sensitive materials, or the like. In addition to the reverse flow heat exchanger, the cooling system comprises a thermal energy sink. This thermal energy sink is configured to remove thermal energy (cool) at least one energy partition of a fluid passing through the thermal energy sink. The thermal energy sink is configured for performance of an endothermic process, as discussed elsewhere herein.

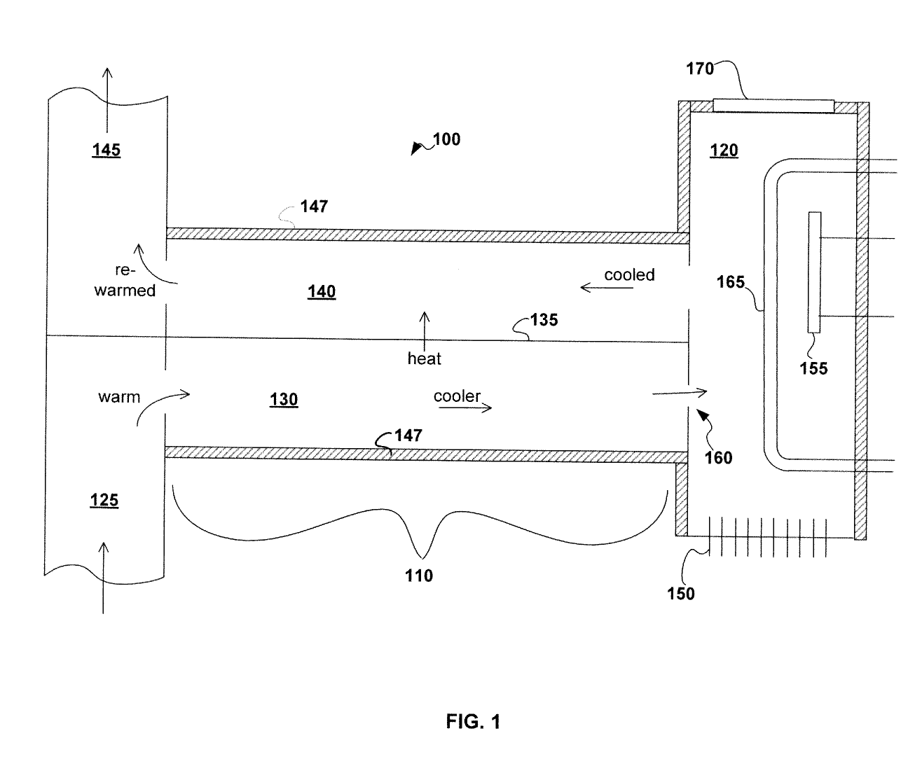

FIG. 1 depicts a System 100 comprising a Reverse Flow Heat Exchanger 110 and a Thermal Energy. Sink 120, according to various embodiments of the invention. A fluid is passed through an Inlet 125 into a Input Channel 130 of Reverse Flow Heat Exchanger 110. In Input Channel 130 heat is exchanged through a Barrier 135 to a Output Channel 140. As such, the fluid within Input Channel 130 is cooled while fluid within Output Channel 140 is warmed. The fluid leaves Output Channel 140 though an Outlet 145. The fluid may be gas or liquid. Reverse Flow Heat Exchanger 110 and/or parts of Thermal Energy Sink 120 are optionally covered by an Insulation 147. Thermal Energy Sink 120 may include a discrete volume or merely a continuation of Input Channel 130 and Output Channel 140.

Between Input Channel 130 and Output Channel 140 the fluid is cooled within Thermal Energy Sink 120. Thermal Energy Sink 120 is configured for the performance of an endothermic process by which thermal energy is removed from at least one partition of the fluid. This endothermic process can be active or passive. For example, in one embodiment Thermal Energy Sink 120 includes a passive Heat Sink 150 configured for radiation or convection of heat into the surrounding environment. This embodiment is possible when the temperature of the fluid is greater than that of the surrounding environment.

In some embodiments, Thermal Energy Sink 120 includes an active Electronic Cooling Device 155, such as a Peltier cooling device or the like. In some embodiments, Thermal Energy Sink 120 is configured to produce an endothermic expansion of the fluid or a phase change (e.g., condensation) of the fluid in order to achieve cooling. For example, an Orifice 160 disposed between Input Channel 130 and Thermal Energy Sink 120 may be configured to create a sudden pressure drop in the fluid that produces an adiabatic expansion into Thermal Energy Sink 120.

In some embodiments, Thermal Energy Sink 120 includes a Cooling Tube 165 configured to contain a cooling fluid at a temperature lower than that of the fluid passing through Reverse Flow Heat Exchanger 110. This cooling fluid may include liquid Nitrogen, liquid Helium, Freon, an alcohol, or some other coolant. Cooling Tube 165 may include fins or other features (not shown) configured to maximize surface area and thus facilitate heat exchange between Cooling Tube and the fluid that passes through Reverse Flow Heat Exchanger 110.

In some embodiments. Thermal Energy Sink 120 is configured for cooling via an endothermic chemical reaction. This chemical reaction may include the mixing of two or more reagents, the making and/or breaking of chemical bonds, and/or the reaction of the fluid within Thermal Energy Sink 120 with a solid material (e.g., a catalyst). For example, the endothermic chemical reaction may include dissolving of a salt in a liquid. These and other types of endothermic reactions that may be included in various embodiments of the invention as will be apparent to those of ordinary skill in the art. The endothermic reaction may occur just within Thermal Energy Sink 120 and/or within parts of Input Channel 130 and/or Output Channel 140.

Thermal Energy Sink 120 optionally includes a Contact Surface 170 configured to make thermal contact with an external object. This external object may be a superconductor, an electronic circuit, a sensor, or the like. For example, in some embodiments Contact Surface 170 is configured to cool tissue in medical applications. Contact Surface 170 may comprise a variety of shapes and materials. For example, in some embodiments, Contact Surface 170 includes a copper point external to Thermal Energy Sink 120 and/or a high surface area structure within Thermal Energy Sink 120. The structure within Thermal energy Sink 120 is configured to facilitate thermal contact with the fluid that passes through Reverse Flow Heat Exchanger 110.

In some embodiments, an optional fan or pump (not shown), can be placed at Inlet 125 and/or the Outlet 145 to improve fluid flow through System 100. The fan or pump is optionally controlled by a circuit and/or temperature sensor described elsewhere herein.

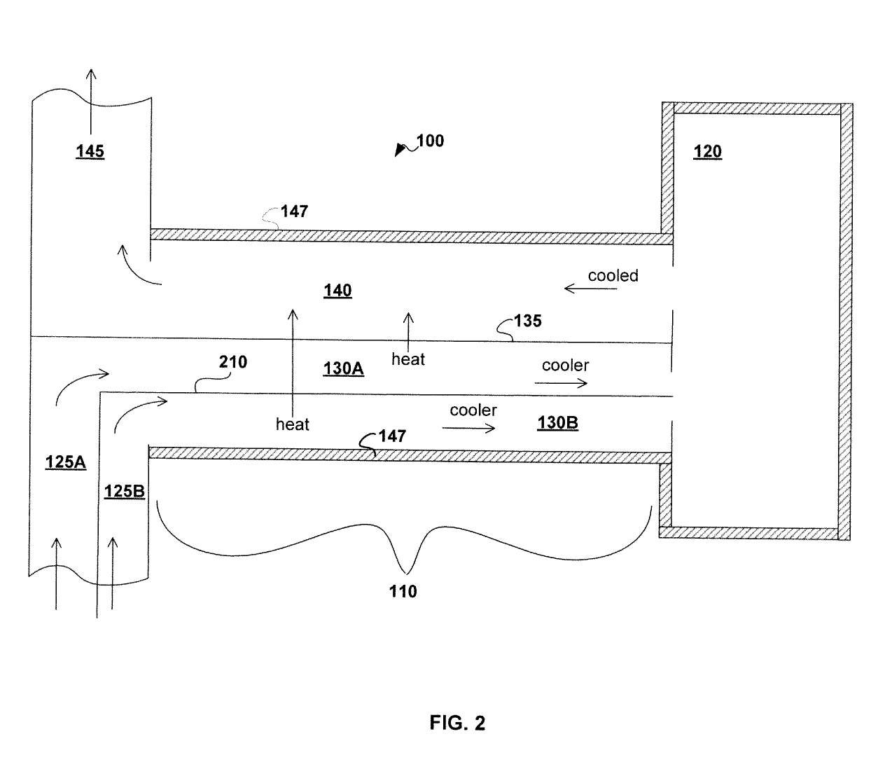

FIG. 2 depicts embodiments of System 100 wherein Reverse Flow Heat Exchanger 110 comprises more than one Inlet 125 and more than one Input Channel 130. These plurality of Inlet 125 and Input Channel 130 are labeled 125A, 125B and 130A, 130B, respectively. Input Channels 130A and 130B are separated by a Divider 210. Optionally, both of Input Channels 130A and 130B are disposed in thermal contact with Output Channel 140. As such, heat from both input channels may pass through Barrier 135 to Output Channel 140. Input Channels 130A and 130B may include adjacent pipes or concentric pipes, for example.

Input Channel 130A and Input Channel 130B are configured to convey separate reagents to Thermal Energy Sink 120 wherein they can react in an endothermic reaction. For example, the mixture of nitrogen rich chemicals or salts into water just as is used in prior art cold packs. Another example of endothermic reactions includes the catalysis (reduction) of NOₓ.

The embodiments of System 100 illustrated in FIGS. 1 and 2 may take a variety of geometries, some of which are discussed elsewhere herein. For example, the relative sizes and shapes of Input Channel 130 and Thermal Energy Sink 120 may be substantially different in alternative embodiments of the invention. In some embodiments Input Channel 130 is disposed within Output Channel 140 or vice-versa. Thermal Energy Sink 120 is optionally part of Reverse Flow Heat Exchanger 110 that is indistinguishable from other parts of Input Channel 130 and Output Channel 140. Input Channel 130 and Output Channel 140 optionally include surface textures and/or protrusions configured to facilitate thermal conduction across Barrier 135. Reverse Flow Heat Exchanger 110 and/or Thermal Energy Sink 120 optionally includes a circular cross-section. System 100 optionally includes a temperature sensor coupled to a transducer and/or controller (not shown).

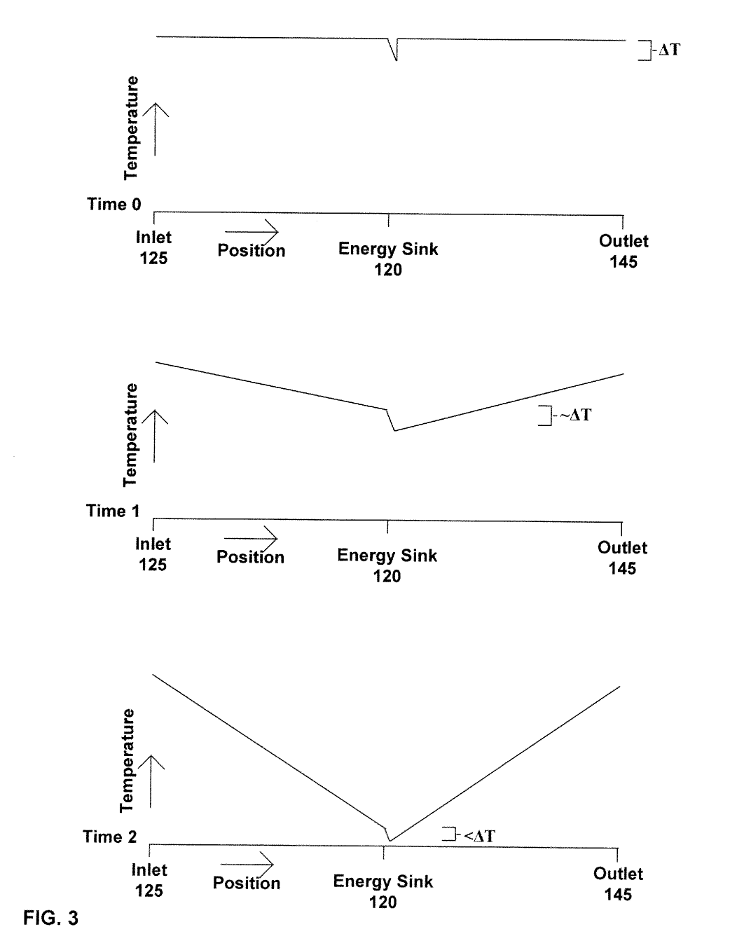

FIG. 3 illustrates approximate temperature as a function of position in System 100 of FIG. 1 at various times, according to various embodiments of the invention. These positions are along the fluid path between Inlet 125 and Outlet 145. At startup (Time 0) cooling is applied and Thermal Energy Sink 120 provides a change in temperature of ΔT to that part of the fluid disposed within Thermal Energy Sink 120. Fluid within other areas (e.g., Input Channel 130 and Output Channel 140 are at the temperate of the fluid as received at Inlet 125.

At a Time 1 fluid that has received the temperature decrease of ΔT travel into Output Channel 140 of Reverse Flow Heat Exchanger 110 toward Outlet 145. This results in cooled fluid within Output Channel 140. Heat from the fluid within Input Channel 130 (that has yet to enter Thermal Energy Sink 120) traverses across Barrier 135 to the cooled fluid within Output Channel 140. As a result, the fluid now entering Thermal Energy Sink 120 is now pre-cooled. When this pre-cooled fluid reaches Thermal Energy Sink 120 it is further cooled by approximately ΔT due to the endothermic processes within Thermal Energy Sink 120. However, because the fluid was pre-cooled the absolute temperature reached is now lower than at Time 0. Reverse Flow Heat Exchanger 110 thereby produces a feedback effect wherein an thermal energy sink can be used to decrease the temperature at an intermediate point within Reverse Flow-Heat Exchanger 110. Through this process the temperature in the combustion chamber 120 is reduced until a steady state is reached at a Time 2. At this time, fluid leaving through Outlet 145 is slightly cooler than fluid entering Inlet 125. This temperature difference is a function of the efficiency and insulation of Reverse Flow Heat Exchanger 110. This process of lowering temperature within System 100 and the systems used to perform this process are referred to herein as a temperature ladder. A temperature ladder can reduce the lowest temperature which fluids reach, improve the efficiency of the cooling process, and increase the amount of time the fluids are at a reduced temperature.

In some embodiments, a steady state is reached when the energy removed by Thermal Energy Sink 120 is equal to the energy difference between fluids entering Inlet 125 and fluids exiting Outlet 145 plus energy lost or received through walls of exhaust system 100. In some embodiments, a steady state is reached when the temperature within Thermal Energy Sink 120 is the same as a temperature of Cooling Tube 165. Under these conditions, Cooling Tube 165 no longer removes energy from the fluids within Thermal Energy Sink 120. In some embodiments, a steady state is reached because the temperature drop achieved per unit of energy added to the fluids declines as the absolute temperature decreases. As a result the temperature drop (ΔT) in the Thermal Energy Sink 120 at Time 0 may be greater than the temperature drop achieved at steady state at Time 2.

Steady state temperature may also be dependent on energy added to the Thermal Energy Sink 120 via Contact Surface 170, or the like. For example, if Contact Surface 170 is used to cool electronics then heat is conveyed from these electronics to the fluid within Thermal Energy Trap 120. On average the thermal energy removed from Thermal Energy Trap 120 via thermal expansion, Cooling Tube 165, Electronic Cooling Device 155, or the like should be greater than the thermal energy added via Contact Surface 170 in order to maintain the temperature ladder within System 100. However, in applications in which the thermal energy added via Contact Surface 170 is momentary, this added thermal energy can be momentarily greater than the energy removed. For example, in medical applications wherein Contact Surface 170 is used to freeze or cool tissue the energy added by contact with the tissue can be momentary. In these applications the fluid within Reverse Flow Heat Exchanger 110 and Thermal Energy Sink 120 may provide a thermal mass that allows for better maintenance of the steady state temperature during momentary addition of energy.

Different types of thermal energy removal strategies may result in different types of steady states. For example if energy is removed via Electronic Cooling Device 155, then the minimum steady state temperature may be limited by the minimum temperature of Electronic Cooling Device 155. If energy is removed via an endothermic chemical reaction between two reactants, then the minimum steady state temperature may be limited by the efficiency of Reverse Flow Heat Exchanger 110, Insulation 147 and/or any processes that add energy to Thermal Energy Sink 120.

The combination of Reverse Flow Heat Exchanger 110 and Thermal Energy Sink 120 result in the fluid included therein being reduced to a lower temperature, cooled more efficiently, and/or cooled for a longer time than would be achieved by Thermal Energy Sink 120 alone. In various embodiments, fluids within Thermal Energy Sink 120 reach absolute temperatures 10, 15, 25, 50 or 75% lower than the temperature of fluid entering Reverse Flow Heat Exchanger 110.

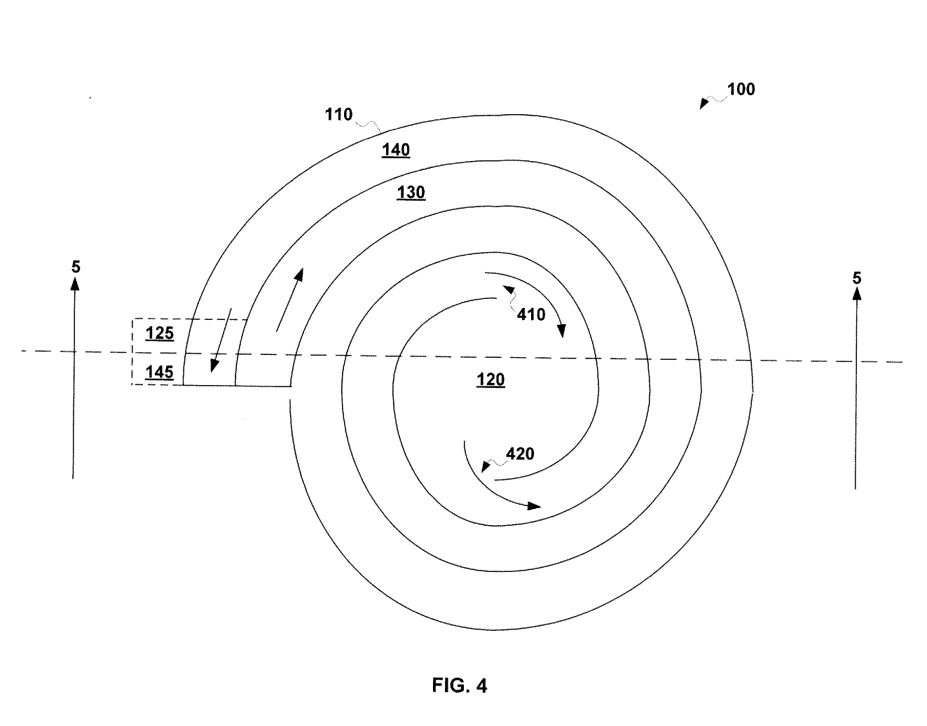

FIG. 4 depicts System 100 of FIG. 1 in a spiral configuration, according to various embodiments of the invention. Reverse Flow Heat Exchanger 110 comprises Input Channel 130 and Output Channel 140 interleaved in a spiral. Thermal Energy Sink 120 is disposed near the central region of the spiral. System 100 also comprises Inlet 125 and Outlet 145 shown in dashed lines to represent that these components are optionally out of the plane of the drawing. Optionally, the embodiments of System 100 illustrated in FIG. 4 are constructed by coiling stainless steel, copper or other suitable material around an axis.

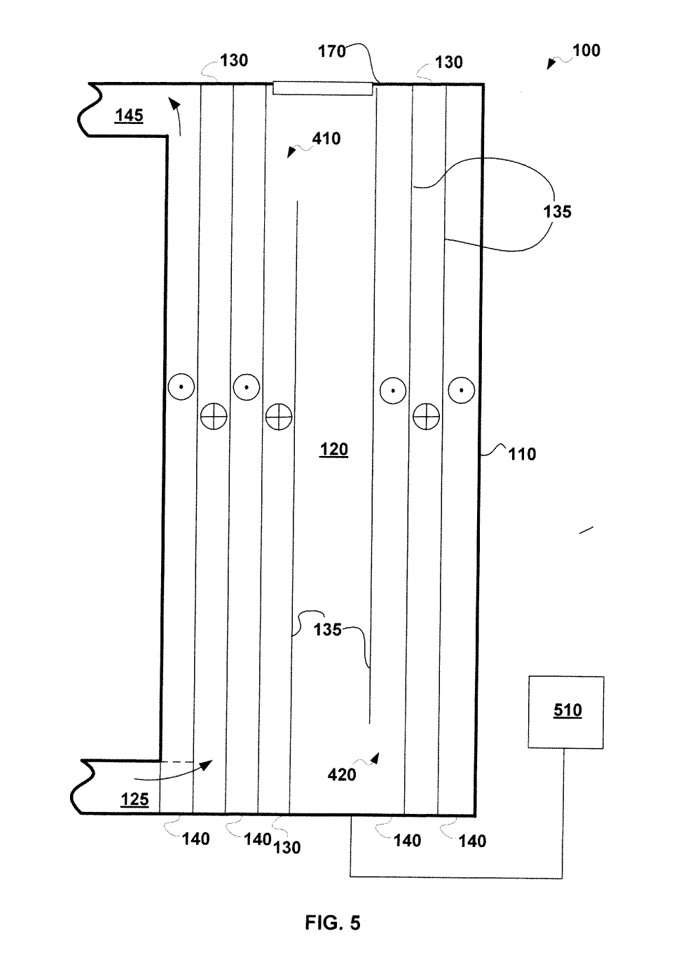

Thermal Energy Sink 120 is optionally coupled to Input Channel 130 and Output Channel 140 by Vents 410 and 420, respectively. Vents 410 and 420 may be open along the entire length of Thermal Energy Sink 120, or as illustrated in FIG. 5, may be disposed at specific parts of Thermal Energy Sink 120.

FIG. 5 depicts a cross sectional view along a vertical axis (line 5-5) of the system of FIG. 4, according to various embodiments of the invention. Regions of fluid flow into the plane of the page are depicted using an arrow pointing into the page. Regions of fluid flow out of the plane of the page are depicted using an arrow pointing out of the page. Inlet 125 and Outlet 145 are optionally located at opposite ends of Reverse Flow Heat Exchanger 110. When the system is operated in a vertical orientation, Inlet 125 is optionally above or below Outlet 145. As illustrated in FIG. 5, Contact Surface 170 may be located at one end of Thermal Energy Sink 120.

The size of System 100 may vary widely among different embodiments. For example, in some embodiments System 100 is configured as a hand held probe. In these embodiments, all or part of Reverse Flow Heat Exchanger 110 is configured to fit in a hand. The tip of this hand held probe may comprise Contact Surface 170. In some embodiments. System 100 is configured to fit within a electronics console such as a computer case or computing rack. In some embodiments, System 100 is of a size sufficient to cool large superconducting magnets such as those that may be found in an imaging device, an accelerator, a mass spectrometer, or the like. Further dimensions, such as the number of spiral windings, widths of Input Channel 130 and Output Channel, thicknesses of Barrier 135, may be varied according to specific needs. For example, in various embodiments. System 100 has a height between 0.5-2 feet, between 2-3 feet, between 2.5 to 4.5 feet, or greater than 4 feet.

In some embodiments, System 100 is configured such that the cooling of fluid within Thermal Energy Sink 120 drives fluid flow through Reverse Flow Heat Exchanger 110. For example, cooling of a gas within Thermal Energy Sink 120 will cause the gas to fall. If Vent 420 is disposed below Vent 410 this falling air will drive air flow through System 100. As this process continues, the incoming air is pre-cooled by the outgoing air and the temperature within the combustion chamber decreases as described elsewhere herein.

As illustrated in FIG. 5, System 100 may further include a Control Circuit 510 configured to monitor and control temperatures and flows within System 100. For example, control circuit 830 may control operation of Thermal Energy Sink 120 by controlling current to Electronic Cooling Device 155, power to a fan, power to a pump, or the like. In some embodiments, Control Circuit 510 is configured to monitor the temperature within Thermal Energy Sink 120, e.g. using a thermal couple, and to control the operation of Thermal Energy Sink 120 responsive to this temperature. In some embodiments, Control Circuit 510 is configured to maintain Thermal Energy Sink 120 at a target temperature. A control circuit similar to Control Circuit 510 may be included in other embodiments of the invention disclosed herein.

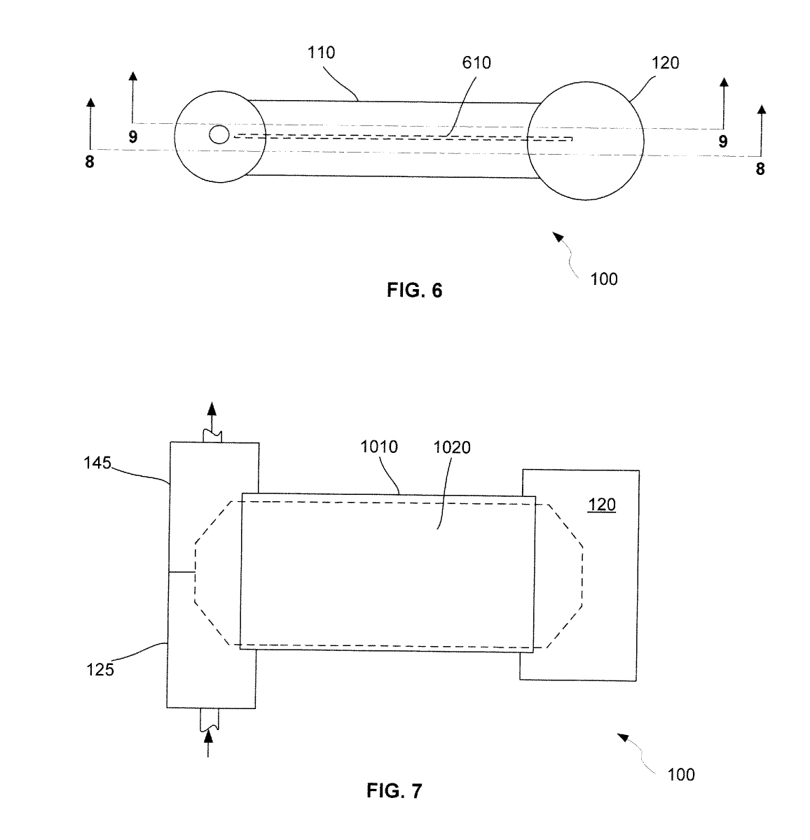

FIGS. 6 and 7 depict a side and top views, respectively, of the system of FIG. 1 in a plate configuration, according to various embodiments of the invention. These embodiments comprises an instance of Reverse Flow Heat Exchanger 110 including two chambers separated by one or more Plate 610 (shown in dashed lines to indicate that the plate is internal to Reverse Flow Heat Exchanger 110). Plate 610 is an embodiment of Barrier 135. One chamber of Reverse Flow Heat Exchanger 110 is in fluid communication between Inlet 125 and Thermal Energy Sink 120. A second chamber of Reverse Flow Heat Exchanger 110 is in fluid communication between Thermal Energy Sink 120 and Outlet 145. These chambers function as Input Channel 130 and Output Channel 140. The System 100 including Plate 610. Thermal Energy Sink 120, Inlet 125 and Outlet 145 can be constructed using any suitable material such as, for example stainless steel, copper, titanium, plastics, glasses, ceramics, or the like. The Plate 610 is typically constructed of a material with high thermal conductivity, such as a metal, to provide good heat transfer between the chambers.

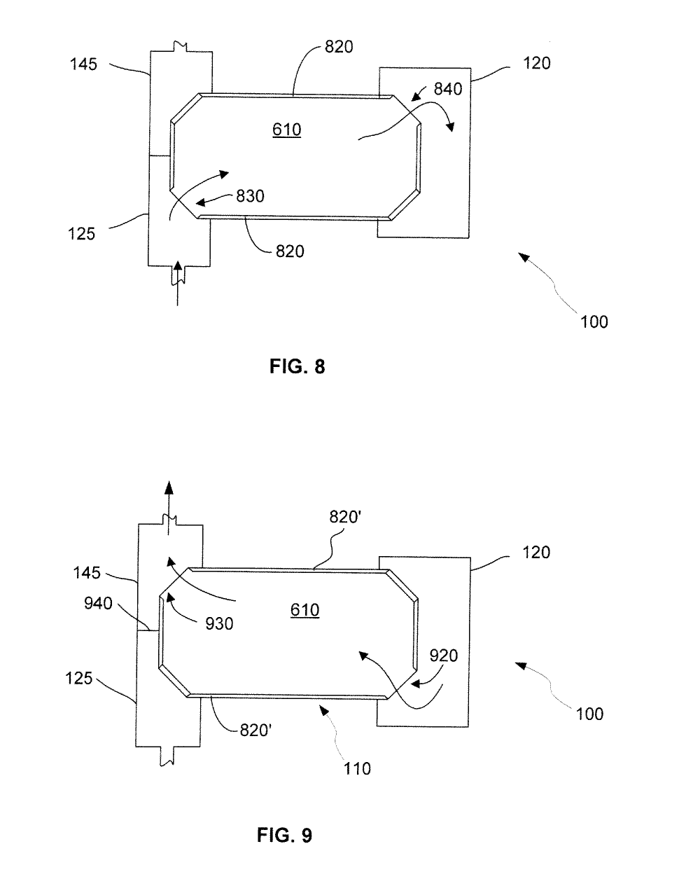

FIGS. 8 and 9 depict cross sectional views of the system of FIG. 6, according to various embodiments of the invention. In FIG. 8, a cross section is taken along section 8-8 of FIG. 6 through Input Channel 130. The Inlet 125 is formed between the Plate 610, an exterior wall of Reverse Flow Heat Exchanger 110 (not visible in this perspective), and two spacers 820 that maintain a proper spacing between the exterior wall and the Plate 610. Openings between the spacers 820 form an Inlet 830 and an Outlet 840 are in fluid communication with Inlet 125 and Thermal Energy Sink 120, respectively. Inlet 830 and Outlet 840 are optionally disposed at diagonally opposing corners of Reverse Flow Heat Exchanger 110 so that fluid flows diagonally across the surface of Plate 610.

In FIG. 9, a cross section is taken along section 9-9 of FIG. 6 through an Output Channel 140. Output Channel 140 is formed between Plate 610, another exterior wall of Reverse Flow Heat Exchanger 110, and two Spacers 820′. As described above with respect to FIG. 8, openings between the Spacers 820′ form an Inlet 920 and an Outlet 930 that provide fluid communication between Thermal Energy Sink 120 and Outlet 145. In various embodiments. Inlet 125 and Outlet 145 comprise a tube sectioned by a Baffle 940, configured to prevent direct fluid communication there between. In these embodiments. Inlet 125 and Outlet 145 optionally share a common longitudinal axis that is approximately parallel to a plane defined by the Plate 610.

In the illustrated embodiments, the Inlet 920 and Outlet 930 are disposed on opposing corners of Output Channel 140 such that the fluid flow is diagonal across the Output Channel. Arranging the fluid flows along the diagonals of Input Channel 130 and Output Channel 140 provides the fluid greater opportunity to transfer heat there between.

Some embodiments of the Reverse Flow Heat Exchanger 110 include multiple Plates 610 disposed to form multiple channels. These channels may be in parallel so as to form multiple parallel Input Channel 130 and Output Channel 140 and thus provide greater fluid throughput. Alternatively, these channels may be in series so as to form a longer total path length for fluid to flow and thus provide for greater heat transfer. Reverse Flow Heat Exchanger 110 is optionally assembled by alternatively stacking Plates 610 and Spacers 820. These part may then be welded together to produce a stacked geometry.

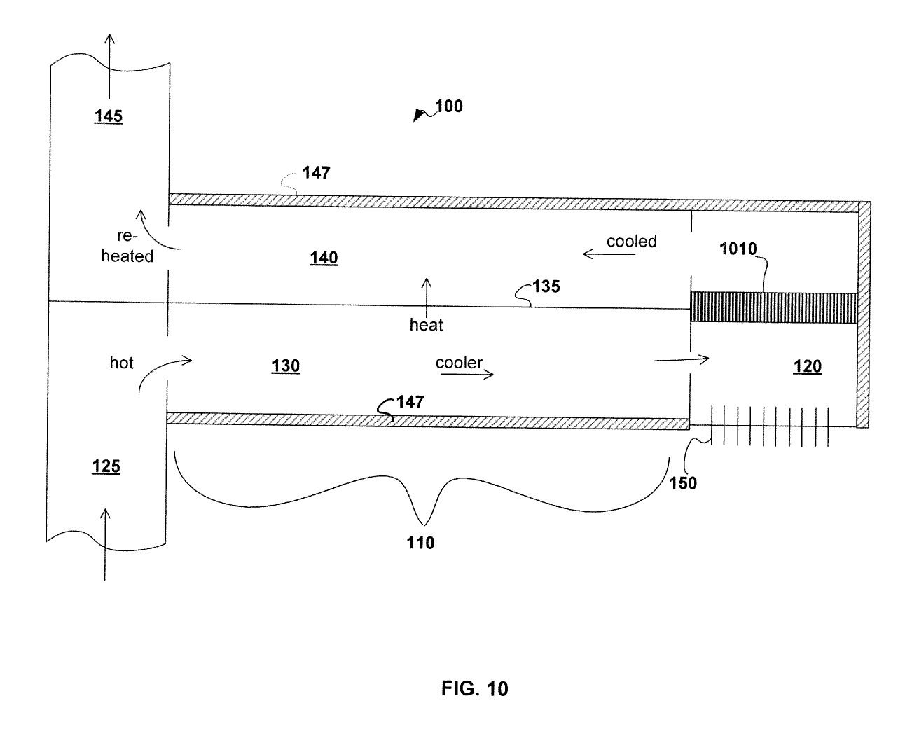

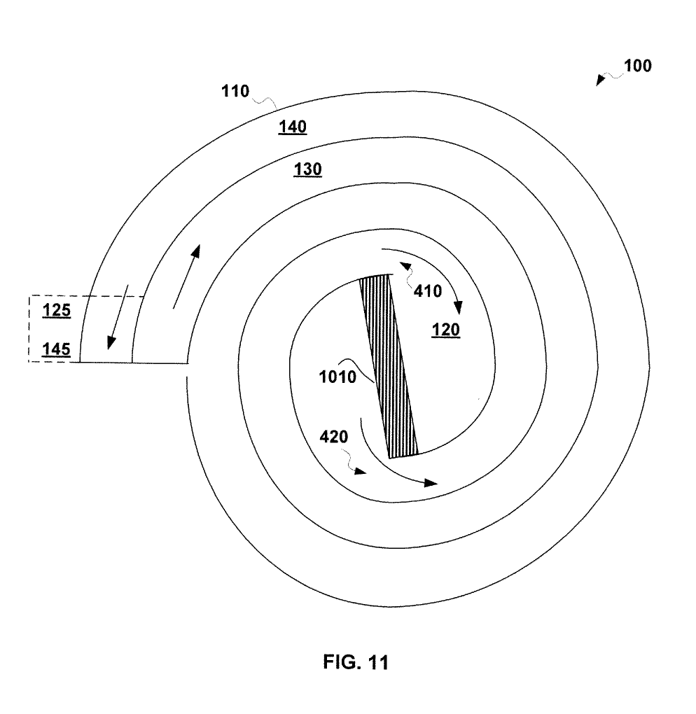

FIG. 10 depicts the system of FIG. 1 further comprising a Catalyst 1010, according to various embodiments of the invention. These embodiments may be used when a preferred operating temperature of Catalyst 1010 is lower than a temperature of a fluid entering Inlet 125. For example if the fluid entering Inlet 125 comprises an exhaust gas produced at a high temperature. Catalyst 1010 may be configured to clean this exhaust gas. Catalyst 1010 may be configured to catalyze oxidation and/or reduction reactions of undesirable gases in the exhaust stream such as NOₓ compounds. For example, Catalyst 1010 may be configured to oxidize carbon monoxide to carbon dioxide, oxidize un-burnt hydrocarbons to carbon dioxide and water, or reducing nitrogen oxides to nitrogen and oxygen

Typically, Catalyst 1010 is configured for a gas to flow through. For example. Catalyst 1010 can comprise a substrate supporting a catalytic material. In various embodiments, the catalytic material is added to a washcoat and applied to the substrate. The washcoat provides increased surface area for the catalytic material. Exemplary substrates comprise a mesh of stainless steel or a porous ceramic, and other suitable materials will be familiar to those skilled in the art. Suitable catalytic materials include platinum, palladium, and rhodium, and other suitable materials will be familiar to those skilled in the art. An exemplary washcoat comprises a mixture of silicon and aluminum, and other suitable materials familiar to those skilled in the art can be employed. Alternatively, Catalyst 1010 can comprise a simple mesh of the catalytic material without a substrate, or a catalytic material deposited directly onto a substrate. Catalyst 1010 optionally includes the Type I or Type II catalysts typically used in vehicle catalytic converters.

In various embodiments, Catalyst 1010 is configured to operate between approximately 800-900, 900-1000, 1000-1100 or greater than 1100°F.

In some embodiments, an exhaust stream is cleaned by first raising temperature of the exhaust using a temperature increasing temperature ladder (as taught in the applications cited elsewhere herein). This may cause the combustion of particulate matter within the exhaust. Following removal of combustible particles, the exhaust gas is passed into the system illustrated in FIG. 10 where it is cooled prior to interaction with Catalyst 1010.

FIG. 11 depicts the system of FIG. 4 further including Catalyst 1010, according to various embodiments of the invention. In these embodiments. Catalyst 1010 is disposed in the central region (Thermal Energy Sink 120) of a spiral geometry. An exemplary method for manufacturing the embodiments illustrated in FIG. 11 comprises attaching opposite sides of Catalyst 1010 or support thereof to the ends of two metal sheets. The metal sheets are then wrapped around Catalyst 1010 to form the Input Channel 130 and Output Channel 140 of Reverse Flow Heat Exchanger 110. A spacer placed at either side of one of the two sheets can be used to maintain the proper spacing between the two metal sheets. After the sheets have been wrapped around Catalyst 1010, the Inlet 125 and Outlet 145 are optionally attached to Reverse Flow Heat Exchanger 110. End caps are then attached to the assembly to seal the top and bottom ends In some embodiments, one or more of these end caps are removable for easy replacement of the catalyst. For example, one of the end caps could be threaded or tack welded. The catalyst is optionally mounted on a support structure that can be removed when one of the end caps are removed. System 100 may include slots, tracks, guides, or the like to receive the catalyst support structure.

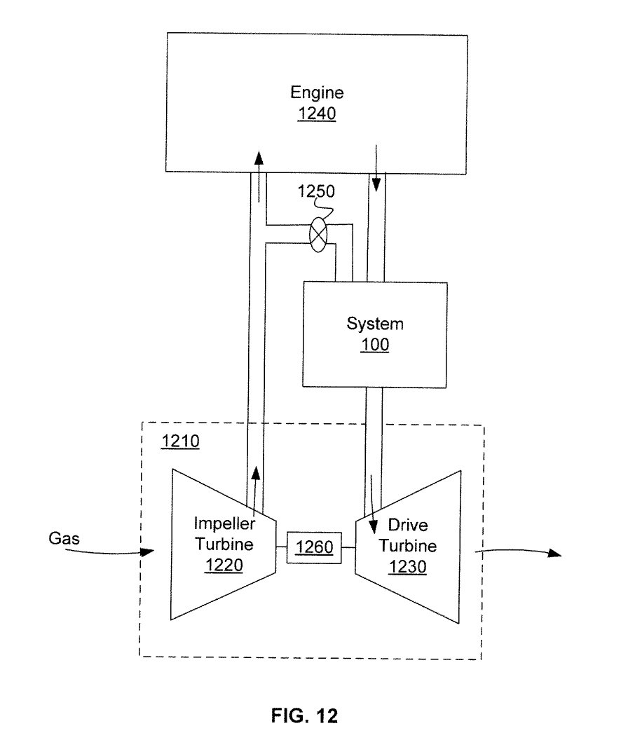

FIG. 12 depicts System 100 of FIG. 1 coupled to a Turbine System 1210, according to various embodiments of the invention. Turbine System 1210 comprises two turbines. For example. Turbine System 1210 may include a first turbine referred to herein as Impeller Turbine 1220 (also known as a compressor) and a second turbine referred to herein as a Drive Turbine 1230 (also known as a drive turbine). Turbine System 1210 may be included in a wide variety of systems including, for example, a power plant, a pump, high powered machinery, a ground vehicle, a ship, an aircraft engine, a train, a tank, or the like. Turbine System 1210 can include radial or axial turbines.

As shown in FIG. 12, air enters the Turbine System 1210 at Impeller Turbine 1220 wherein it is compressed. This compressed air is then directed to an Engine 1240 where it is typically mixed with a fuel and burned. In various embodiments, Engine 1240 comprises an a combustion chamber, internal combustion engine, a diesel engine, a gas engine, a jet engine, or the like.

Combustion of the compressed air within Engine 1240 generates a hot exhaust that may include unwanted compounds and/or particles. This hot exhaust is directed into Inlet 125 of an embodiment System 100 that includes a cooling temperature ladder and Catalyst 1010, e.g., an embodiment such as those illustrated in FIGS. 10 an 11. Within System 100 the hot exhaust is cooled to an operating temperature of Catalyst 1010 as described elsewhere here in. In some embodiments, System 100 comprises both a heating temperature ladder configured to burn particles and a cooling temperature ladder. A heating temperature ladder is described in the various U.S. patent applications cited herein. The combination of both a heating and cooling temperature ladder allows for particles to be burned before they reach Catalyst 1010. The hot exhaust gas may be at pressures of 2 to 4 atmospheres, 4 to 6 atmospheres, 6 to 10 atmospheres, 10 to 20 atmospheres, or in some embodiment higher pressures.

An optional valve controlled Bypass 1250 is used to pass some of the air compressed using Impeller Turbine 1220 to System 100 without passing through Engine 1240. This air may be used to as a cooling source within Thermal Energy Sink 120 and/or may be added to the exhaust from Engine 1240 prior to Thermal Energy Sink 120. For example, control of the fraction of air passed through Bypass 1250 may be used to control the temperature at Thermal Energy Sink 120 and, thus, the temperature of Catalyst 1010.

Engine 1240 and or Drive Turbine 1230 may be configured to propel a vehicle, generate electricity, or perform some other mechanical work. Turbine System 1210 optionally includes an Auxiliary Unit 1260. Auxiliary Unit 1260 may include a generator, a transmission, an electric motor, a pump, or the like.

In various embodiments, Catalyst 1010 is operated at less than 1600° F. or less than 1250° F. while the exhaust gasses received from Engine 1240 are at a greater temperature, e.g., 1500, 1650, 1700, 1800, or 2500° F. In some embodiments, System 100 includes a variable embodiment of Heat Sink 150 that can be manipulated so as to control the temperature within Thermal Energy Sink 120. If reaction of the exhaust gasses is exothermic, then whatever cooling system is used in Thermal Energy Sink 120 is typically able to remove this added energy.

In some embodiments, the weight of catalytic material within Catalyst 1010 is about 50% or less of the weight of catalytic material in a catalyst disposed in an exhaust system of the prior art. The reduced weight of catalytic material is sufficient because of a higher pressure of the exhaust gasses at the catalyst relative to the prior art. For example, the exhaust pressure at the catalyst may be 2, 3, 4 or more Atmospheres. A typical automotive catalytic converter of the prior art may include between 3 and 7 grams of platinum while various embodiments of the invention may achieve better catalysis with less than 3.0, 2.5, 2.0 or 1.5 grams.

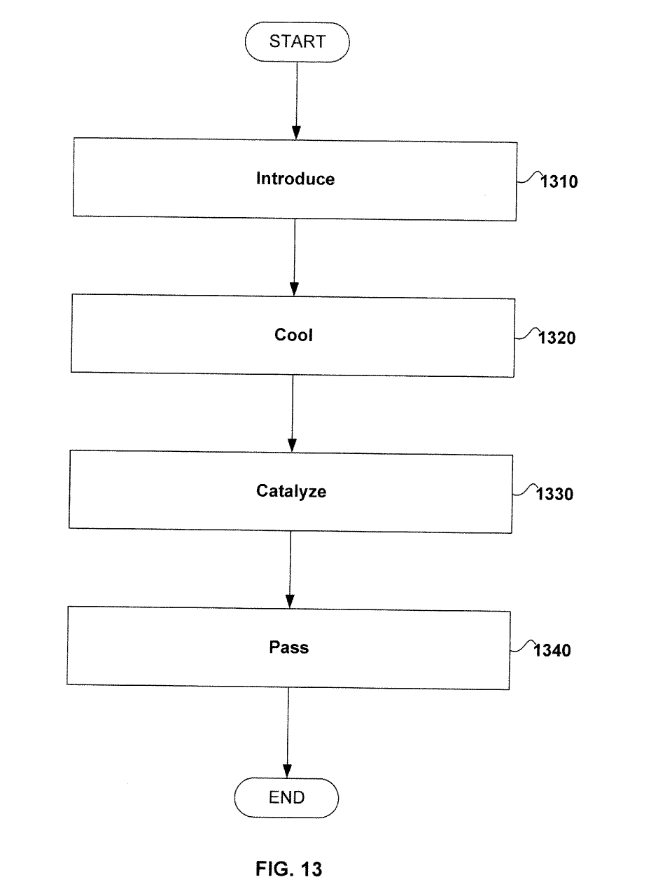

FIG. 13 illustrates a method of cooling, according to various embodiments of the invention. While this method is described with respect to System 100 it may be performed using other systems.

In an Introduce Step 1310, a fluid is introduced into Input Channel 130 of Reverse Flow Heat Exchanger 110 via Inlet 125. This fluid may be a gas, may be compressed, and may have a temperature that is greater or less than ambient temperature.

In a Cool Step 1320 the introduced fluid is cooled within Thermal Energy Sink 120 at an intermediate point within Reverse Flow Heat Exchanger 110. As described herein, this cooling may be active or passive. Cooling may be to temperatures above or below ambient temperature.

In an optional Catalyze Step 1330, the cooled fluid is allowed to contact Catalyst 1010. This contact will typically result in chemical reactions within the cooled fluid. In some embodiments Catalyst 1010 is configured to remove undesirable molecules from the cooled fluid via these reactions.

In a Pass Step 1340, the cooled fluid is passed through Output Channel 140 of Reverse Flow Heat Exchanger 110. In this step heat passes from Input Channel 130 to Output Channel 140 such that the fluid within Input Channel 130 is pre-cooled prior to reaching Thermal Energy Sink 120. Through the same process, the fluid within Output Channel 140 is reheated. This reheating may result in a temperature that is near the original temperature of the fluid on entering Inlet 125. This process results in a cooling temperature ladder.

Several embodiments are specifically illustrated and/or described herein. However, it will be appreciated that modifications and variations are covered by the above teachings and within the scope of the appended claims without departing from the spirit and intended scope thereof. For example, while the specification discusses separate parts of the reverse flow heat exchanger and a combustion chamber, there may not be distinct boundaries between these elements. In addition, while various chemical reactions, temperatures and pressures are discussed herein. One of ordinary skill in the art will understand that alternatives are within the scope of the invention.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system Comprising:
a reverse flow heat exchanger configured to receive a fluid; and
a thermal energy sink configured to cool the fluid by removing energy from at least one energy partition of the fluid, the thermal energy sink being disposed within the reverse flow heat exchanger such that the fluid cooled by the thermal energy sink pre-cools the fluid before the received fluid reaches the thermal energy sink.

2. The system of claim 1, wherein the thermal energy sink is configured to create an adiabatic expansion.

3. The system of claim 1, wherein the thermal energy sink is configured to create an endothermic reaction.

4. The system of claim 1, wherein the thermal energy sink is configured to mix two reactants to create an endothermic reaction.

5. The system of claim 4, wherein one of the two reactants includes a salt solution.

6. The system of claim 4, wherein the thermal energy sink comprises a solid state reactant configured to react endothermically with the fluid within the reverse flow heat exchanger.

7. The system of claim 1, wherein the thermal energy sink comprises a Peltier cooling device.

8. The system of claim 1, further comprising a superconductor thermally coupled to the thermal energy sink.

9. The system of claim 1, further comprising a thermal contact surface configured to be cooled by the thermal energy sink.

10. The system of claim 1, further comprising a sensor thermally coupled to the thermal energy sink.

11. The system of claim 10, wherein the sensor comprises an imaging device.

12. The system of claim 1, wherein the reverse flow heat exchanger comprises a plurality of input channels, the plurality of input channels each having an output within the thermal energy sink.

13. The system of claim 1, further comprising a catalyst disposed within the reverse flow-heat exchanger.

14. The system of claim 1, wherein the reverse flow heat exchanger is disposed in a stacked geometry.

15. The system of claim 1, wherein the reverse flow heat exchanger is disposed in a spiral geometry.

16. The system of claim 1, wherein the energy sink comprises a radiant cooling structure.

17. A method comprising:
introducing a fluid into an input of a reverse flow heat exchanger;
cooling the fluid using a thermal energy sink disposed within the reverse flow heat exchanger to produce cooled fluid; and
passing the cooled fluid through an output of the reverse flow heat exchanger so as to pre-cool the fluid introduced into the input of the reverse flow heat exchanger before this fluid reaches the thermal energy sink.

18. The method of claim 17, wherein a pressure of the fluid introduced into the input of the reverse flow heat exchanger is greater than a pressure of the cooled cooling fluid.

19. The method of claim 17, wherein the fluid introduced into the input of the reverse flow heat exchanger comprises a reactant and the cooled fluid comprises a product of a chemical reaction of the reactant.

20. The method of claim 17, wherein the fluid introduced into the input of the reverse flow heat exchanger is introduced as two separate reactants via separate input channels of the reverse flow heat exchanger.

21. The method of claim 17, wherein the cooled fluid is a gas.

22. The method of claim 17, wherein the fluid is introduced into the input of the reverse flow heat exchanger at a temperature greater than ambient temperature.

23. The method of claim 17, wherein a phase of the fluid introduced into the input of the reverse flow heat exchanger is different than a phase of the cooled fluid.

24. The method of claim 17, wherein cooling the fluid comprises establishing an electric field, a magnetic field or an electrostatic potential.

25. The method of claim 17, further comprising cooling a sensor, an electronic circuit, or a superconductor using the pre-cooled fluid.

26. The method of claim 17, further comprising passing the cooled fluid through a catalyst.

27. A system comprising:
an impeller turbine configured to receive a gas;
an engine configured to combust a mixture of a fuel and the gas resulting in an exhaust;
a cooling temperature ladder comprising a reverse flow heat exchanger and a thermal energy sink disposed at an intermediate point within the reverse flow heat exchanger, the cooling temperature ladder configured to cool the exhaust;
a catalyst disposed within the cooling temperature ladder at a position where the exhaust is cooled; and
a drive turbine configured to receive the exhaust from the cooling temperature ladder.

28. The system of claim 27, further comprising a vehicle configured to be propelled by the engine or the exhaust passing through the drive turbine.

29. The system of claim 27, further comprising a bypass configured to pass a fraction of the gas from the impeller turbine to the cooling temperature ladder without passing through the engine.
